(19) United States
(12) Patent Application Publication
(10) Pub. No.: US 2026/0307526 A1
(43) Pub. Date: Oct. 8, 2026

(54) SMART POST SYSTEM FOR VEHICLE AUTHENTICATION AND CHARGING/FUELING

(71) Applicant: PROLOGIS, L.P.

(72) Inventor: Casper Jan-Theo Hendrik Steenkamp, San Francisco, CA (US)

(21) Appl. No.: 19/171,142

(22) Filed: Apr. 4, 2025

(51) Int. Cl. B60L 53/67; B60L 53/16; B60L 53/18; B60L 53/30; B60L 53/31; B60L 53/65; B60S 5/02; G06V 20/52; G06V 20/62

(52) U.S. Cl. CPC B60L 53/67; B60L 53/16; B60L 53/18; B60L 53/305; B60L 53/31; B60L 53/65; B60S 5/02; B60L 2250/30; G06V 20/52; G06V 20/625; G06V 2201/08

(57) ABSTRACT

A system facilitates electric vehicle (EV) charging using one or more posts mounted on a foundation, integrating communication, imaging, and control functionalities. The posts enable communication with EV operators via an intercom and a light source. A camera mounted on a post captures images of the EVs. A computer system processes these images to determine charging authorization. Based on the authorization, the computer system controls the light source to indicate each vehicle's charging status. The light source guides each EV to a designated charging post. The computer system controls the designated post to initiate the charging process.

### BACKGROUND

Electric vehicle charging infrastructure is evolving to meet the growing demands of commercial and industrial applications. Modern charging systems sometimes use cable management to handle charging cables for rapid charging of vehicles. These systems can incorporate different components to assist operators in managing charging equipment. Advanced charging installations sometimes feature status indicators and/or safety systems to enhance operational efficiency and user safety. Conventional implementations can use mechanical and/or electrical systems to provide cable support, with some solutions incorporating smart features for vehicle authentication and charging status indication. However, existing systems lack effective integration of advanced monitoring and communication capabilities.

### BRIEF DESCRIPTION OF THE DRAWINGS

Detailed descriptions of implementations of the present technology will be described and explained through the use of the accompanying drawings.

FIGS. 1A-1E are perspective, front, rear, right, and left views, respectively, of an electric vehicle (EV) charging island system configured in accordance with embodiments of the present technology.

FIG. 2 is a block diagram that illustrates an example system that can implement aspects of the present technology.

FIG. 3 is a block diagram that illustrates an example post that can implement aspects of the present technology.

FIG. 4 is a flow diagram that illustrates an example process for operating a smart post system.

FIG. 5 is a flow diagram that illustrates an example process for operating a smart post system.

FIG. 6 is a flow diagram that illustrates an example process for operating a smart post system.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein are methods, systems, and apparatuses for electric vehicle (EV) charging infrastructure and hydrogen fueling stations. The technologies disclosed herein integrate advanced monitoring and communication features while handling heavy-duty charging cables and hydrogen fueling hoses. Rapid commercial and industrial growth demands more reliable EV charging systems. However, the lack of advanced monitoring and communication capabilities in existing systems fails to meet modern operational requirements. For example, conventional solutions generally fall short in providing advanced monitoring and communication capabilities such as vehicle authentication and status monitoring. Moreover, conventional cable management solutions can lead to cable damage and pose ergonomic difficulties for operators.

The implementations disclosed herein include smart post systems, which integrate advanced monitoring features with mechanical cable management for EV charging and fueling of fuel cell vehicles. The implementations include structural support for a canopy, enhanced monitoring capabilities using cameras, programmable light emitting diode (LED) beacons, area lighting, intercoms, and/or emergency controls mounted on smart post structures designed for weather protection and serviceability. The disclosed systems are modular and adaptable and can accommodate different cable or hose types and operational requirements while reducing maintenance needs. The disclosed smart monitoring features enhance management of heavy-duty EV charging and hydrogen fueling systems. The integration of advanced monitoring capabilities can meet modern operational demands, enabling functionalities such as vehicle authentication and real-time status updates. The modular design provides adaptability and customization to meet specific site requirements, ensuring reliable and efficient performance across varying operational needs.

In some implementations, a charging/fueling system features one or more smart posts and/or charging posts to authenticate vehicles for charging/fueling and facilitate communication with vehicle operators. At least one of the posts is equipped with a camera to capture images of the vehicles. One or more LED beacons having programmable multi-color status indicators can be mounted on at least one of the posts to communicate the charging bay status. The posts can have an intercom to enable communication with the operators. A computer system, linked to the cameras, LED beacons, and intercom, processes the captured images to determine if a vehicle is authorized to charge/refuel. The computer system controls the LED beacon(s) to display the charging/fueling status and guide the vehicle to a specific post for charging/fueling. The computer system and/or a controller controls the post to start the charging/fueling process. The integration of the cameras for vehicle identification provides that only authorized vehicles can access the charging/fueling resources.

In some implementations, a charging/fueling system uses one or more cameras mounted on one or more posts to capture one or more images of a vehicle's license plate. A computer system uses the image(s) to recognize the license plate and determine whether the vehicle is allowed to charge or fuel at the station. If the vehicle is authorized, the computer system turns on a configurable color LED beacon light on the post to signal that the vehicle session is active. The system determines whether the vehicle is hooked up to either a charging cable or a hydrogen fueling hose on a post. Once connected, the system starts the process of charging the vehicle or fueling it with hydrogen. The automated processes disclosed make it easier for vehicles to utilize the system.

In some implementations, the smart post system incorporates an emergency stop system and various safety protocols to provide operational integrity. The system can include emergency stop buttons mounted on the smart posts for easy user access. Activation of an emergency stop button sends a signal to a controller, triggering a dual safety action: an upstream shunt trip breaker is activated to cut off incoming power to the skid/posts, and/or a breaker is engaged to shut down equipment (e.g., on the skid itself). The system can include one or more accelerometers to detect impacts or collisions with the charging infrastructure. Upon detecting an impact exceeding a predefined threshold, an accelerometer sends a signal to the controller, initiating emergency power disconnection sequences involving upstream and breakers (e.g., on the skid).

The benefits and advantages of the disclosed smart post systems include the incorporation of advanced monitoring capabilities for automated vehicle authentication and status indication. The disclosed cameras'multiple detection ranges and remote adjustment capabilities provide more accurate license plate recognition from images compared to traditional methods. The emergency stop system's integration with upstream power controls enhances safety without the addition of complexity to the cable management system. The programmable LEDs can display different colors and patterns to indicate the status of the charging or fueling process, providing clear visual cues to users. Furthermore, the system's user-friendly design ensures that the cables and hoses are managed efficiently, reducing the risk of damage and the need for extensive maintenance.

Further, the methods disclosed herein can cause a reduction in greenhouse gas emissions compared to traditional methods for EV charging, hydrogen fueling, and transportation. Every year, approximately 40 billion tons of CO² are emitted around the world. Further, conventional methods for transportation that rely on the use of gas-powered vehicles can exacerbate the causes of climate change. The implementations of the smart post system and the heavy duty EV charging systems disclosed herein reduce and/or prevent additional greenhouse gas emissions into the atmosphere. For example, the smart post's ability to guide EVs and other vehicles directly to appropriate charging stations reduces vehicle idling and unnecessary vehicle movements, thereby reducing indirect emissions from vehicle operations. The disclosed approaches also incorporate passive environmental controls using a translucent canopy structure, which provides natural lighting while offering protection from environmental elements. This reduces the need for additional powered lighting during daylight hours. The modular design enables improved positioning of charging stations and more efficient power distribution, while the integrated monitoring system improves efficiency of charging sessions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

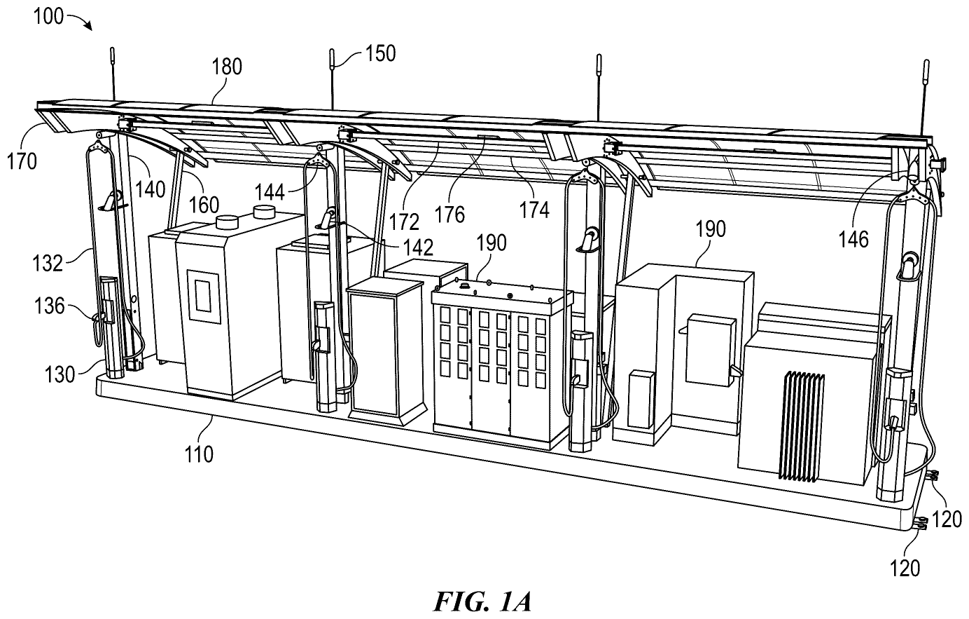

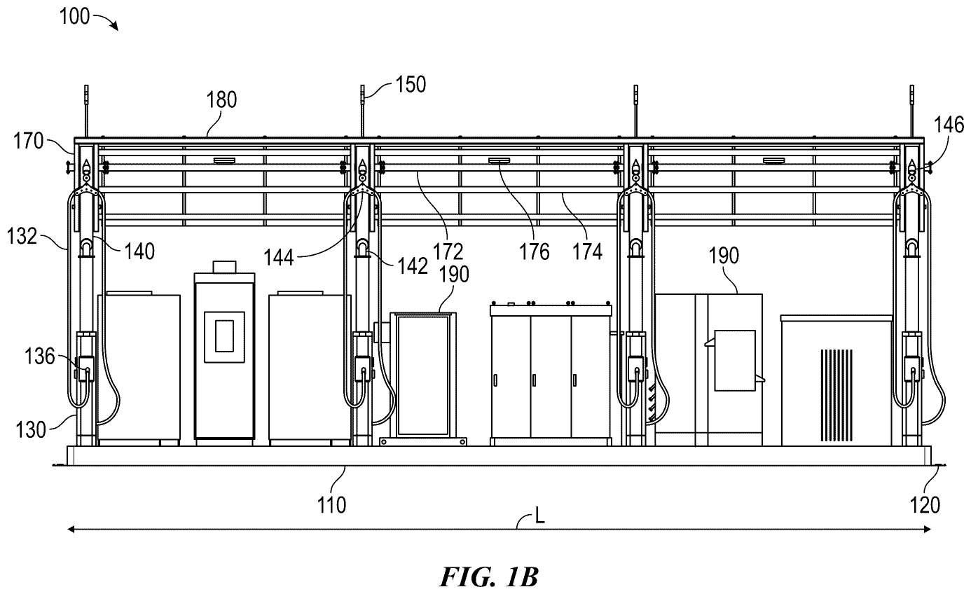

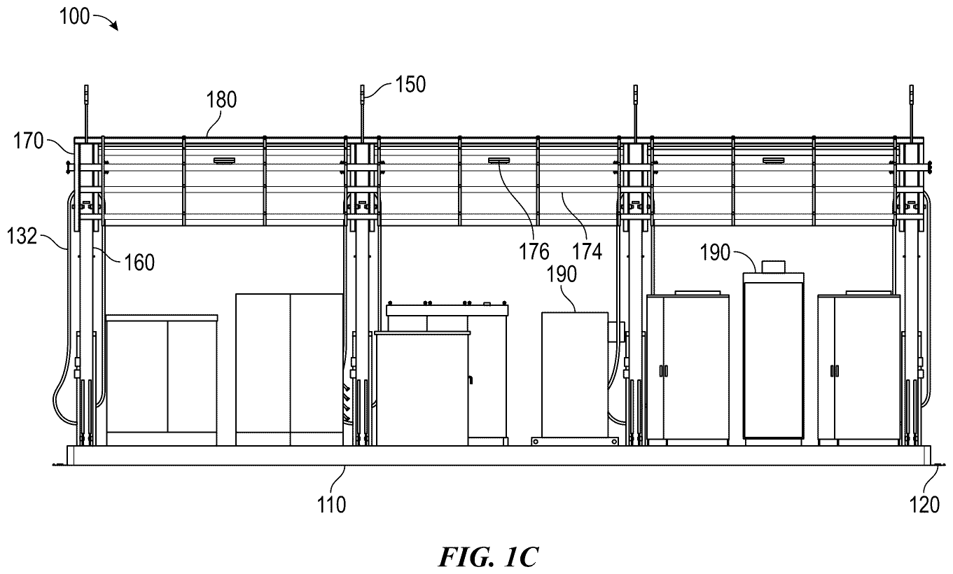

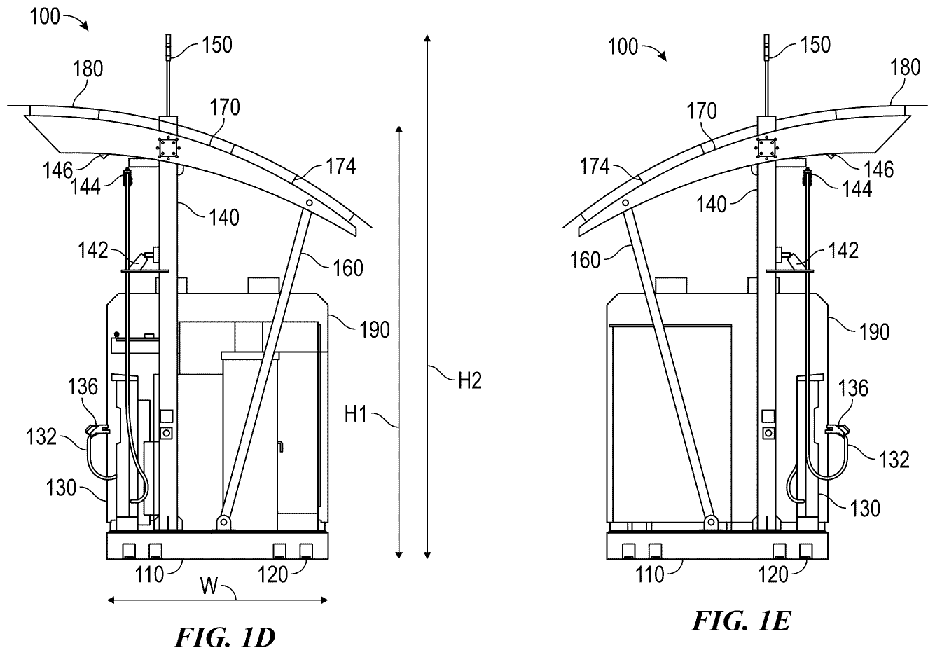

FIGS. 1A-1E are perspective, front, rear, right, and left views, respectively, of an electric vehicle (EV) charging island system 100 (“the system 100”) configured in accordance with embodiments of the present technology. Referring to FIGS. 1A-1E together, the system 100 can include a skid 110, multiple charging posts 130, multiple smart posts 140, multiple support struts 160, a canopy 180, and multiple electrical components 190.

The skid 110 can have a generally flat form factor and can serve as a platform for the other components of the system 100. In the illustrated embodiment, the skid 110 has a generally rectangular shape with rounded corners. The skid 110 can have a length L (FIG. 1B) between about 400-600 inches (e.g., 516 inches) and a width W (FIG. 1D) between about 80-120 inches (e.g., 96 inches). The skid 110 can also include multiple anchors 120 that can releasably secure the skid 110 (and thus the entire system 100) onto a surface, such as metal, cement, or other substrate on-site. In the illustrated embodiment and as best seen in FIGS. 1D and 1E, the skid 110 includes four pairs of anchors 120, each pair positioned along either the left or right sidewall of the skid 110 and adjacent to either the front or rear wall of the skid 110.

The multiple charging posts 130 can each be mounted on the skid 110. In particular, in the illustrated embodiment, a first charging post 130 is mounted on the front-left corner of the skid 110, a second charging post 130 is mounted on the front-right corner of the skid 110, a third charging post 130 is positioned between the first and second charging posts 130, and a fourth charging post 130 is positioned between the second and third charging posts 130. In some embodiments, adjacent charging posts 130 are spaced apart equally. Each charging post 130 can include a charging cable 132 and a connector 136 that a user can connect to an electric vehicle (EV) to charge the EV and/or operate hydrogen fueling hoses.

The multiple smart posts 140 can each be mounted on the skid 110 or other foundation. In particular, in the illustrated embodiment, a first smart post 140 is positioned adjacent to and rear of the first charging post 130, a second smart post 140 is positioned adjacent to and rear of the second charging post 130, a third smart post 140 is positioned adjacent to and rear of the third charging post 130, and a fourth smart post 140 is positioned adjacent to and rear of the fourth charging post 130. As illustrated in FIGS. 1A-1E, the multiple smart posts 140 can each include a vertical column and can together support the canopy 180 thereon. In some embodiments, each smart post 140 also includes a camera 142, a cable guide assembly 144, a light source 146, and an indicator 150, each mounted on the vertical column. The camera 142 can be positioned above the corresponding charging post 130 and oriented to face the area forward of the corresponding charging post 130. Therefore, the cameras 142 can capture, e.g., the EVs and/or personnel using the system 100. Each cable guide assembly 144 can be positioned above the corresponding camera 142 and can support (e.g., suspend) the charging cable 132 of the corresponding charging post 130. Each light source 146 can be positioned above the corresponding cable guide assembly 144 and can be oriented to illuminate the area forward of the corresponding charging post 130. Each indicator 150 can extend upward from the vertical column and above the canopy 180.

The multiple support struts 160 can each be mounted on the skid 110. In particular, in the illustrated embodiment, a first support strut 160 is positioned adjacent to and rear of the first smart post 140, a second support strut 160 is positioned adjacent to and rear of the second smart post 140, a third support strut 160 is positioned adjacent to and rear of the third smart post 140, and a fourth support strut 160 is positioned adjacent to and rear of the fourth smart post 140. As illustrated in FIGS. 1A-1E, the multiple support struts 160 can each extend upward from the skid 110 at a rearward angle. Each pair of a smart post 140 and a support strut 160 can support a pair of multiple arched beams 170.

The canopy 180 can be mounted on the multiple arched beams 170. More specifically, the system 100 can further include multiple canopy support beams 174 each coupled to upper surfaces of the multiple arched beams 170 and extending laterally thereacross. As illustrated in FIGS. 1D and 1E, different ones of the multiple canopy support beams 174 (e.g., I-beams) can be coupled to different points along the curvature of the arched beams 170. The canopy 180 can be mounted on the multiple canopy support beams 174. As best seen in FIGS. 1D and 1E, the canopy 180 can have a curvature corresponding to the curvature of the multiple arched beams 170 such that, e.g., a front portion of the canopy 180 is substantially horizontal and a rear portion of the canopy 180 is angled. In some embodiments, the canopy 180 includes solar panels that can, e.g., power or charge one or more of the electrical components 190.

Referring to FIG. 1D, the system 100 can have a first height H1 excluding the indicators 150 (e.g., up to the highest portion of the canopy 180) and a second height H2 including the indicators 150. The first height H1 can be between about 180-220 inches (e.g., 193 inches). The second height H2 can be between about 200-250 inches (e.g., 227 inches). It is appreciated that the given ranges of the length L, the width W, the first height H1, and the second height H2 are merely illustrative example ranges, and that each dimension can be smaller or greater than the given ranges.

The system 100 can further include multiple horizontal beams 172 and multiple lighting devices 176. Each horizontal beam 172 can extend between adjacent pairs of the multiple arched beams 170 and below the canopy 180. The multiple lighting devices 176 can each be mounted on one of the horizontal beams 172. One, two, or more lighting devices 176 can be mounted on each horizontal beam 172. The lighting devices 176 can be oriented to illuminate a lower surface of the canopy 180. In some embodiments, the canopy 180 is composed of polycarbonate or other transparent/translucent material such that the canopy 180 can both (i) allow sunlight to pass through and (ii) reflect the light emitted by the multiple lighting devices 176 to indirectly illuminate the area below the canopy 180.

The multiple electrical components 190 can each be mounted on the skid 110 or other foundation, and can include one or more types of devices suitable for delivering charge to EVs connected to the charging cables 132 and the connectors 136. For example, the multiple electrical components 190 can include at least one, two, three, four, or more of the following: a generator set, a battery, a transformer, a converter, a splitter, an inverter, a network box, and/or the like. It is appreciated that the specific electrical components to be included in the system 100 can be customized for the specific application. For example, if the system 100 is to be connected to a power grid such that EVs can be charged via utility power, one or more transformers can be included among the multiple electrical components 190. If the system 100 is to be connected to a power grid and capable of generating and storing energy, one or more transformers, one or more generator sets, and one or more batteries can be included among the multiple electrical components 190. If the system 100 is not to be connected to a power grid (e.g., due to the location of the installation site), one or more generator sets and/or one or more batteries can be included among the multiple electrical components 190 (e.g., without a transformer). In some embodiments, the arrangement of the multiple electrical components 190 can be selected to evenly distribute the weights thereof on the skid 110.

In some embodiments, the system 100 further includes multiple lifting lugs (not shown in FIGS. 1A-1E). The lifting lugs can be permanently or removably mounted on the skid 110, and can facilitate handling of the system 100 during, e.g., installation of the skid 110 onto a surface.

It is appreciated that the illustrated embodiment of the system 100 in FIGS. 1A-1E is merely one example, and that various features of the system 100 can be modified within the scope of the present technology. For example, while the charging posts 130 and the smart posts 140 are illustrated as mounted on the skid 110, the skid 110 can be omitted from the system 100, and the charging posts 130 and the smart posts 140 can be mounted on a different foundation (e.g., a concrete slab). As other examples, (i) the skid 110 can include a different number and/or arrangement of the anchors 120, (ii) the skid 110 can have different shapes and/or dimensions, (iii) the system 100 can include a different number of charging posts 130, smart posts 140, and/or support struts 160, (iv) the canopy 180 can have a different shape and/or size, (v) the multiple electrical components 190 can vary, and/or the like. Additionally or alternatively, one or more components (e.g., the multiple lighting devices 176) can be omitted from and/or additional components not shown (e.g., cables extending through the skid 110) can be included in the system 100.

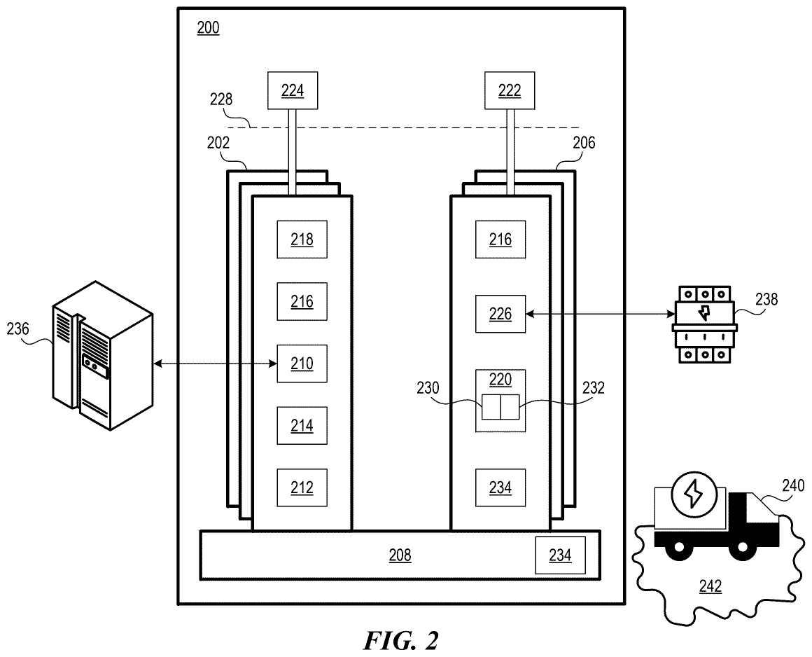

FIG. 2 is a block diagram that illustrates an example system 200 that can implement aspects of the present technology. The example system 200 (sometimes referred to as a smart post system or a smart charging system) facilitates electric vehicle charging and/or hydrogen fueling of vehicles while incorporating monitoring, communication and safety features. For example, the system 200 uses one or more smart posts 202 and/or one or more charging post 206 to integrate charging infrastructure with intelligent monitoring capabilities. Each smart post 202 serves as an intelligent structural element, constructed as a vertical column designed to withstand environmental conditions while supporting multiple smart components. Each smart post 202 is mounted vertically on a skid (e.g., the skid 110 illustrated and described in more detail with reference to FIGS. 1A-E) or other foundation, with various components arranged to enable vehicle authentication, charging status indication, and/or cable management. Likewise, implementations can include different and/or additional components or can be connected in different ways.

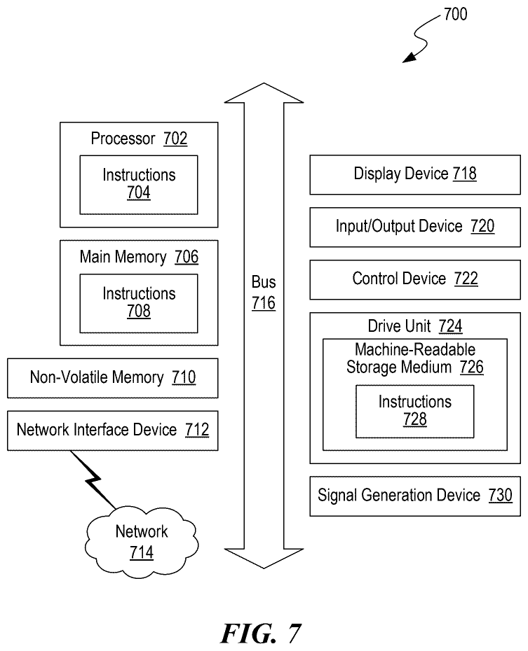

In some implementations, one or more cameras 218, lighting elements (e.g., LED beacons 224 and/or light sources 222), and/or one or more computer systems 210 or controllers 226 are mounted on or communicably coupled to one or more smart posts 202 and/or one or more charging posts 206 to create an intelligent charging interface that can provide vehicle authentication, authorize vehicles for charging/fueling, guide vehicle operators or autonomous vehicles to designated posts, and/or monitor charging/fueling operations, and. The computer system 210 and the controller 226 shown by FIG. 2 can be the same device or separate devices and can be mounted on a smart post 202 or on a charging post 206. Multiple networked computer systems and controllers can also be part of the system 200. The computer system 210 and controller 226 are implemented using components of the example computer system 700 illustrated and described in more detail with reference to FIG. 7.

The computer system 210 can control operation of the smart post 202, which is mounted on the skid 208 (or other foundation). The skid 208 facilitates installation of the posts 202, 206 and potential relocation if needed. The modular design approach allows for flexible deployment while maintaining system integrity. In some implementations, various components and posts described herein are mounted below a canopy 228 that provides weather protection for the components and/or mounting support for the LED beacons 224. This structural element helps enable reliable operation of the system 200 in various weather conditions.

The system 200 can detect vehicle presence and authenticate/authorize vehicles prior to charging/fueling operations. For example, a camera 218 can be specifically oriented to capture images of an area 242 forward of the smart post 202 or skid 208. The computer system 210 is configured to process the images to detect vehicle presence and automatically activate appropriate visual indicators (e.g., LED beacons 224). For example, when a vehicle 240 approaches, the cameras 218 capture one or more images of the vehicle 240. The computer system 210 can perform license plate recognition on the images to authenticate vehicles for charging, such that only authorized vehicles can access the charging post 206. The computer system 210 can perform the authentication process before enabling power delivery through the charging cable 230.

In some implementations, the controller 226 manages power distribution/delivery from upstream power sources 238 to charging posts and/or hydrogen fuel delivery. The controller 226 can also manage the charging/fueling operations. The controller 226 can manage energy distribution and communication of various functions. For example, the controller 226 can provide notifications to operators (via the speaker(s) 214 and/or LED beacons 224) about charging status, power delivery, and system operations. When vehicles are authenticated through license plate recognition, the system 200 can use the controller 226 to track and communicate which vehicles are using specific posts, enabling detailed usage monitoring and reporting.

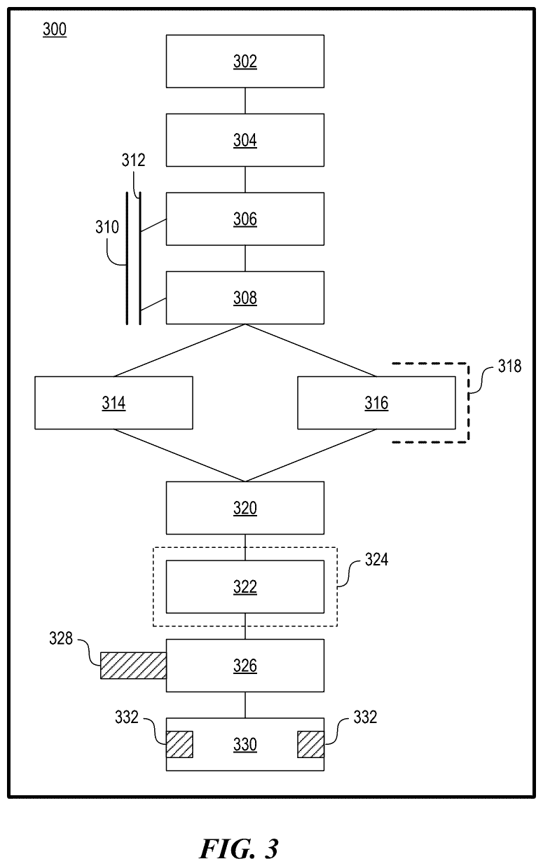

The system 200 can include multiple sensors 212, 234 for monitoring the charging environment (e.g., temperature sensors, humidity sensors, accelerometers), one or more speakers 214 (that can be part of an intercom) for audio communications, and a wireless module 216 for connectivity between the electronic components (e.g., intercom), the computer system 210, communication modules on vehicles, and/or mobile devices carried by operators. The wireless module 216 is implemented using components of the example computer system 700 illustrated and described in more detail with reference to FIG. 7. An example intercom is shown by FIG. 3.

The wireless module can include Bluetooth, Wi-Fi, cellular, radio frequency identification (RFID), and/or near field communication NFC communication capabilities. The wireless module 216 facilitates local communication and connectivity with vehicles and the broader charging network. The speakers 214 can be mounted on the smart post 202 and/or charging post 206 to enable audio communication with users. The speakers 214 can be used for providing instructions, safety warnings, or confirmation messages during the charging process. An intercom can enable two-way communication between users and system operators. In some implementations, various components (e.g., computer system 210, sensors 212, 234, speakers 214, and/or the intercom) can be mounted on the smart post 202 and/or the charging post 206.

The sensors 212 can be strategically positioned throughout the system 200 to monitor various parameters. The sensors 212 can work in conjunction with additional pressure and weight sensors 234 (e.g., that are embedded in the skid 208 or other foundation, or in the area 242 in front of the posts) to provide more comprehensive environmental and operational monitoring. The multiple sensors 212, 234 and the communication elements create an interactive charging experience. For example, the sensors 212, 234 can monitor various parameters, including pressure and weight that can be used to detect vehicle presence and positioning. The sensors 212, 234 work in conjunction with the computer system 210 to enable automated responses and safety features.

The sensors 212, 234 can monitor several parameters for more efficient and safe EV charging. For example, an accelerometer can be integrated into the system 200 to detect impacts or collisions, which can trigger emergency shutdown procedures to disconnect electrical power or hydrogen flow. Additionally, some sensors can monitor the charging cable management system. The system 200 can also be equipped with an emergency stop system (illustrated in FIG. 3) that can be activated manually or triggered by sensor data to provide power/fuel isolation. Sensors 234 (e.g., proximity sensors) can be used to provide vehicle proximity sensing, alerting if the vehicle 240 gets too close to the charging/fueling equipment. The integrated sensors 212 can work together to provide a comprehensive overview of the charging operations, safety conditions, and equipment status.

In some implementations, one or more light sources 222 are used to provide illumination to vehicles and operators (e.g., of the area 242 in front of the charging post or the skid 208 or other foundation) and one or more LED beacons 224 provide visual indicators to operators to maneuver vehicles towards an assigned charging post. Vehicle detection can be integrated with the visual alert mechanisms. For example, when vehicles are detected approaching too close to the charging post 206, the LED beacons 224 can be programmed to flash warning signals. The LED beacons 224 and light sources 222 can work together to provide synchronized visual patterns, guiding authenticated vehicles (vehicle operators or autonomous vehicles) to available charging posts 206. This coordinated detection and response system can operate across multiple networked charging posts 206 to manage vehicle traffic and improve charging station utilization.

In some implementations, the system 200 uses a multi-layered approach for directing vehicles to an assigned charging post. An LED beacon 224 mounted above a vertical post and extending through the canopy 228 is configured to display different colors specifically to direct vehicles to their designated charging posts. For example, the LED beacons 224 associated with available charging posts 206 can blink or emit green light, while the LED beacons 224 associated with occupied charging posts 206 can blink or emit red light. Given the height of the LED beacons 224 (e.g., see the indicators 150 in FIGS. 1A-1E), such indications can be particularly advantageous when, for example, other vehicles (which may be relatively tall) are obscuring view of charging spaces. The LED beacons 224 can also be configured to display different colors and/or patterns to indicate whether a charging stall is private or publicly accessible, whether a charging stall is out of service, whether a vehicle occupying a charging stall is actively being charged or merely idling, and/or the like. The visual guidance can operate in coordination across multiple networked posts to create synchronized visual patterns that guide vehicles between posts. Additionally, the amenity LED lighting (light sources 222) mounted on the posts can shine up onto the translucent canopy 228 and can be computer controlled to change colors, allowing the system to use the entire canopy to help direct vehicles to their proper charging location.

The computer system 210 can coordinate multiple visual elements across multiple charging posts 206, creating an “airport runway lights” effect to guide vehicles to their proper charging location and then provide charging session information. The guidance method provides efficient traffic flow while maintaining safety and proper vehicle-to-post matching. The computer system can also communicate a specific color and blinking pattern to a reservation system that the inbound truck driver has access to on a mobile app. A reservation record can describe this specific visual reservation code, so the arriving truck driver can identify the particular bay that is ready to receive them.

The system 200 can include LEDs on posts 202, 206 at a height specifically designed to be visible from a heavy duty truck cab, providing clear line of sight to the visual indicators. The LEDs can display various information including availability, active charging status, and safety alerts. The system 200 can provide charging status monitoring and alerts through multiple channels. The computer system 210 can also be configured to communicate charging status and post usage information to a remote monitoring system. For example, comprehensive notifications can be communicated regarding charging post usage to an operator's mobile device. The computer system 210 can also communicate charging status and post usage information to a remote monitoring system (e.g., computer server 236), enabling centralized tracking of charging operations. This allows network operators to monitor utilization and status across multiple charging posts.

The system 200 is designed to operate as part of a networked charging infrastructure, where multiple charging posts 206 and/or smart posts 202 can be coordinated together. The networking capability allows the posts to coordinate visual indicators for directing vehicles between posts, creating an efficient charging ecosystem. The networked nature of the system 200 allows multiple smart posts 202 and charging posts 206 to coordinate together, sharing usage information across the charging network. This networked communication enables the system 200 to track utilization rates and manage power distribution more efficiently. The computer system 210 can monitor and report various parameters including charging progress, post availability, and any safety or operational alerts that occur during charging sessions. Additionally, the system's integration with remote monitoring capabilities (e.g., computer server 236) allows it to communicate usage patterns and operational data that can help optimize charging station deployment and utilization.

In some implementations, the system's networked capability allows multiple smart posts 202 to coordinate their visual indicators, creating a comprehensive guidance system that helps maintain proper vehicle positioning across the entire charging island. The LED beacons 224 can display different colors and patterns, allowing the system 200 to communicate when the vehicle 240 has moved out of position and guide it back to the correct location. Additionally, the amenity lighting embedded in the canopy structure can provide supplementary visual cues through its computer-controlled color-changing capabilities.

The system 200 can use a sophisticated LED signaling system to alert when trucks move beyond their assigned charging location. For example, the light source 222 can be configured to flash warning signals when the vehicle 240 approaches too close to a post or moves out of position. In some implementations, the LED beacons 224 are configured to flash warning signals when a vehicle approaches too close to a post. This warning system can work in conjunction with the cameras 218 and sensors 212, 234 that monitor vehicle positioning. The system 200 can also include an emergency stop system and accelerometer-based safety features that can trigger power shutoff. When an accelerometer (within sensors 234) detects a collision or excessive vibration, it sends a signal to the controller 226 and/or computer system 210 that can initiate a cascade of safety actions, including triggering an upstream shunt trip breaker (e.g., connected to upstream power sources 238) to cut power to the skid or other foundation and/or shutting down all onboard power sources including generators and batteries.

When one or more accelerometers detect a collision or excessive vibration error conditions, the LED beacons 224 can provide visual indication of the emergency shutdown state. The controller 226 can initiate power shutoff procedures. The LED beacons 224 across networked charging posts can coordinate their visual patterns to redirect vehicles away from posts experiencing errors. In some implementations, the light sources 222 and LED beacons 224 report various error conditions. For example, the light source 222 and LED beacons 224 can operate together with the computer system 210 to display different visual patterns indicating error states. The light source 222 can be configured to flash warning signals when a vehicle approaches too close to a post, serving as a primary safety alert mechanism. The LED beacons can display different colors to indicate error conditions and direct vehicles away from problematic charging posts.

In some implementations, the LED beacons 224 can handle authentication errors through visual feedback. For example, when the computer system 210 fails to authenticate a vehicle's license plate, the LED beacons 224 can signal this error condition. The computer system 210 can be configured to process authentication failures and control the LED beacons 224 and light source 222 accordingly. Additionally, amenity LED lighting in the canopy structure can be computer controlled to change colors and patterns to provide supplementary error condition notifications. The system 200 can also display charging progress information using progressive fill patterns, allowing it to indicate charging errors or interruptions through changes in the display pattern.

A cable guide assembly 220 (sometimes referred to as a charging cable assembly) can be mounted on the charging post 206 (or the smart post 202) and used to manage the charging cable 230 and the connector 232 for charging EVs. The cable guide assembly 220 is designed for connecting to electric vehicles, featuring robust construction to handle frequent use. The system 200 can include one or more charging cable assemblies 220, each affixed to a respective charging post to facilitate the transfer of electrical power to EVs. Each charging cable assembly 220 includes a charging cable 230, engineered to handle the high power demands of rapid EV charging, and a connector 232 designed for secure and efficient coupling with a vehicle's charging port. The computer system 210 and/or the controller 226 can be configured to monitor the status of these connections. Upon determining that a vehicle is physically connected to a charging cable assembly mounted on a specific post, the computer system 210 can control the charging process. This control includes initiating, regulating, and terminating the flow of electrical energy through the charging cable 230 to the connected vehicle via the connector 232, thereby enabling the charging operation. Similarly, assemblies for hydrogen fueling hoses can be mounted on one or more of the posts 202, 206.

FIG. 3 is a block diagram that illustrates an example post 300 that can implement aspects of the present technology. The post 300 can be implemented as a smart post or as a charging post. The post 300 is implemented as part of EV charging infrastructure and/or hydrogen fueling infrastructure, incorporating advanced monitoring capabilities with mechanical cable/hose management within a unified structure. Especially when networked with other similar posts, the post 300 is sometimes referred to as a smart post system. In some implementations, the example post 300 integrates multiple components within a unified structure, with an LED beacon assembly 302 at the highest point for improved visibility. Likewise, implementations can include different and/or additional components or can be connected in different ways.

The example post 300 can be one of several posts mounted on a skid as described in more detail with reference to FIG. 2, or other foundation. The post 300 serves as an interface for operators of EVs or hydrogen-fueled vehicles, facilitating the communication necessary for initiating and managing the charging/fueling process. The post 300 can be part of a charging island system (as described in more detail with reference to FIG. 1). For vehicle authentication, the post 300 incorporates one or more cameras 304 positioned to capture an image of at least one vehicle approaching the post 300. The camera 304 can be, e.g., an AXIS Q1808-LE bullet camera with sophisticated pan (+180°), tilt (0 to −90°), and roll (−90° to 270°) adjustment capabilities. The camera 304 can provide detection ranges up to approximately 407 meters with varying resolution levels for different functions, from basic vehicle detection to more precise license plate recognition. The camera's mounting position and adjustability provide improved coverage for vehicle authentication and monitoring purposes compared to traditional systems.

In some implementations, the one or more cameras 304 are mounted on the post 300 and oriented to face an area (e.g., area 242 illustrated in FIG. 2) forward of the post 300 to capture images of vehicles. The captured images are processed by a communicably coupled computer system (e.g., computer system 210 of FIG. 2) or controller 320 to determine whether the identified vehicle is authorized for charging/fueling. In some embodiments, the camera 304 includes memory, a processor, and a networking module and is configured to perform the license plate recognition on the captured images. The cameras 304 may possess capabilities such as remote zoom and focus functionality with P-Iris control to ensure accurate plate reading under varying environmental conditions. Multiple cameras 304 can be used in parallel, mounted on one or more smart posts or charging posts, to provide comprehensive vehicle identification data to a computer system.

Further facilitating communication and operational awareness are one or more LED beacons 302 mounted on the post 300 and/or on other posts in the system. Typically positioned at an elevated point on the post 300, such as above the vertical column structure 326 (illustrated and described in more detail with reference to FIGS. 1A-E) and extending above a canopy structure, the LED beacon 302 can include programmable multi-color status indicators. These indicators are controlled by the computer system to convey the charging authorization status (e.g., “authorized to charge,” “must wait 4 hours before receiving charge,” “not authorized to charge at this charging station,” etc.) of an EV. Following successful authentication, the LED beacon 302 can indicate the authentication status of the vehicle using programmable color patterns, to visually guide vehicle operators or autonomous vehicles to designated posts. In some implementations, the computer system coordinates LED beacon patterns across multiple smart posts to direct vehicles to assigned charging stations, potentially using a sequential pulsing effect to guide incoming trucks to their designated bays. Furthermore, the LED beacon 302 can display charging progress information using a progressive fill pattern, allowing operators to readily ascertain the state of charge of their vehicle.

The LED beacon 302, in conjunction with an intercom 316 also mounted on the post 300, provides a multi-modal communication interface between the post 300 and the vehicle operators. The intercom 316 is implemented using components of the example computer system 700 illustrated and described in more detail with reference to FIG. 7. The integrated control of the camera 304 and the LED beacon 302 by the computer system enables automated vehicle authentication and communication of charging status and guidance within the EV charging infrastructure. The intercom 316 provides a direct audio communication channel between the post 300 and the vehicle operators. The intercom 316 can be located at a user-accessible position on the column structure 326, enabling two-way communication during the charging or fueling process. The LED beacon 302 and intercom 316 provide a multimodal communication interface, such that operators receive both visual and auditory cues and can interact with the post 300 for support.

The core intelligence and control of the smart post system reside within a computer system (e.g., computer system 210 of FIG. 2) or controller 326 that is communicably coupled to the camera 304, the LED beacon 302, and the intercom 316. The computer system enables the various functionalities of the charging infrastructure. For example, the computer system processes the images captured by the camera 304 to determine whether a vehicle is authorized for charging. The processing can involve license plate recognition software that compares the captured license plate data against authorized vehicle records. The camera 304, under the control of the computer system, can utilize remote zoom and focus capabilities to provide more accurate license plate reading under diverse conditions.

Upon successful authentication, the computer system controls the LED beacon 302 to indicate the charging authorization status of the vehicle. This control involves transmitting signals to the LED beacon 302 to display programmable multi-color patterns that convey the authorization status to the operator. The LED beacon 302, positioned for visibility, can use different colors and patterns to signal various states, including authorization to charge. The computer system is also configured to control the LED beacon 302 to direct vehicles towards assigned posts for charging or fueling. The guidance can be implemented by coordinating LED beacon patterns across multiple smart/charging posts, potentially creating a sequential “wave” effect to guide incoming vehicles to their assigned charging bays. This feature improves traffic flow and reduces unnecessary vehicle movements within the charging infrastructure.

Once a vehicle is authorized and positioned, the computer system controls the post 300 to charge the vehicle. For example, the controller 320 or computer system manages power delivery through a charging cable 310 connected to the post 300. The computer system can also be configured to detect emergency stop activation via an emergency stop system 314 integrated within the post 300, and to execute emergency response protocols based on sensor data. The computer system may further store charging session data, including vehicle identification and charging parameters, in a database for record-keeping and analysis. The emergency stop system 314 is implemented using components of the example computer system 700 illustrated and described in more detail with reference to FIG. 7. The emergency stop system 314 can include emergency controls such as emergency stop buttons and/or other manual activation points positioned at user-accessible heights.

In some implementations, the emergency stop system 314 and one or more accelerometers are implemented to provide operational safety. For example, the controller 320 can receive an emergency stop signal from the post 300, initiating a sequence that triggers disconnection of electrical power or hydrogen flow to the post 300. The emergency stop system 314 can include manually activated buttons strategically located for easy access. In parallel, the charging system can include accelerometers communicably coupled to the computer system, and designed to detect physical impacts to the overall system. Upon receiving a signal from an accelerometer indicating an impact, the computer system can likewise trigger disconnection of electrical power or hydrogen flow. The disclosed safety protocols, triggered by either the manual emergency stop or the automatic detection of an impact by the accelerometer, provide rapid cessation of energy delivery, mitigating potential hazards and protecting equipment and personnel. The controller 320 can manage emergency responses, activating upstream and breakers (e.g., connected to upstream power sources 238 illustrated in FIG. 2) to achieve power isolation and deactivate onboard energy sources such as generators and batteries.

One or more accelerometers can be integrated within the skid (or other foundation) or the vertical column structure 326 to enable impact detection and automatic safety system activation. The post 300 can incorporate accelerometers that detect collisions or impacts to the skid structure or other foundation. When triggered, an accelerometer sends a signal to the controller 320. For example, the controller 320 initiates two safety actions: it triggers an upstream shunt trip breaker to cut off power being delivered to the post 300, and it activates the breaker to shut down equipment on the post 300. The accelerometers can be tuned specifically for each installation site to avoid false triggers. If the skid or other foundation is impacted and potentially decoupled from power cables, the emergency stop system 314 prevents live cables from being exposed.

The post 300 can include an LED light source positioned (such as above the cable guide assembly and/or camera 304) and oriented to illuminate an area adjacent to the skid or other foundation. The LED light source provides localized illumination, enhancing visibility for operators during charging operations, especially under low-light conditions. The LED light source can also serve an indicative purpose, e.g., to indicate charging status. Further, the LED beacon 302 can be configured to display a warning signal to prevent a collision between a vehicle and the skid or the post 300 while directing the vehicle towards a particular post. For example, the programmable multi-color status indicators of the LED beacon 302 can emit visual alerts, such as flashing lights or specific color patterns, that signal to the driver if the vehicle is approaching the skid or the post 300 at an unsafe angle or distance. As the computer system controls the LED beacon 302 to guide the vehicle towards its designated charging location, it can simultaneously monitor vehicle proximity using data from the camera 304 or other sensors. If an imminent collision risk is detected, the computer system can trigger the LED beacon 302 to display a warning signal, thereby providing a timely visual cue for the operator to take corrective action.

The post 300 can include a service panel 318 to enhance the maintainability and operational efficiency of the intercom 316. Additionally, the cable management apparatus can also include quick-release access panels for efficient installation and removal, providing convenient access to internal components for servicing, inspection, or component replacement. The integration of service panels enables maintenance to be performed with reduced downtime, improving the overall functionality and reliability of the EV charging and/or hydrogen fueling infrastructure. In additional implementations, the post 300 includes a ratcheting pulley mechanism 306 for controlled cable movement in one direction while locking when movement ceases. The post 300 can be equipped with a charging cable 310 (or a hydrogen fueling hose) and a connector for the vehicle (e.g., vehicle 240 illustrated in FIG. 2). The ratcheting pulley mechanism 306 can work in conjunction with a grooved roller assembly 308, which includes multiple rollers within a U-shaped housing. A support cable 312 can be coupled between the grooved roller assembly 308 and the ratcheting pulley mechanism 306.

The post 300 can also include a counterweight system 322 that includes a primary counterweight member and removable weight plates. The counterweight system 322 can be contained within an enclosure 324 that provides environmental protection and includes ventilation and service access points. The enclosure 324 may be securely mounted to the larger structure of the charging station using mounting provisions 328. In addition, a mounting plate 330 can be used for securing various components to the vertical column structure 326. Furthermore, the skid may include integrated lift points 332 that facilitate handling of the system during installation.

In some implementations, the post 300 is used to fuel hydrogen fuel cell vehicles using a hydrogen fueling hose that can transfer high-pressure gaseous hydrogen from a storage tank at a fueling station to the vehicles. The hydrogen fueling hose is designed to withstand pressures of hydrogen gas and provide safe delivery during refueling. The hydrogen fueling hose is typically thicker and heavier, and has reinforced layers compared to standard fuel hoses due to the higher pressures involved. For example, the post 300 can be implemented to enable the operation of a hydrogen fueling hose that can handle pressures up to approximately 700 bar.

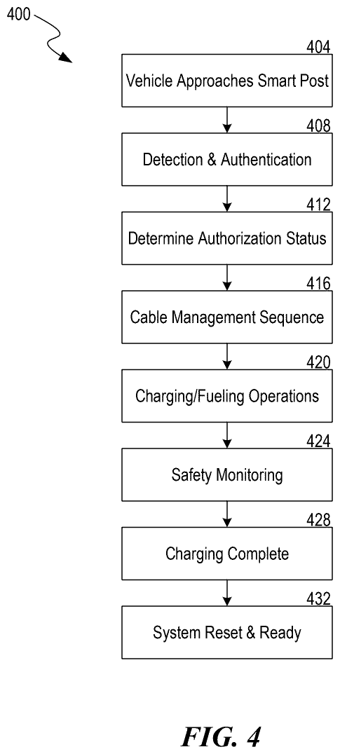

FIG. 4 is a flow diagram that illustrates an example process 400 for operating a smart post system. In some implementations, portions of the process 400 are performed by a computer system. For example, the portions can be performed by the computer system 700 illustrated and described in more detail with reference to FIG. 7. Likewise, implementations can include different and/or additional steps or can perform the steps in different orders. The process 400 includes an operational sequence from initial vehicle approach through charging completion. This integrated process combines vehicle authentication, cable management, charging operations, and safety monitoring within a unified control framework. FIG. 4 demonstrates how mechanical and electronic systems work in concert to enable efficient charging while maintaining safety and operational control.

The smart post system's operational flow can begin when a vehicle approaches (404) the charging station, triggering the initial detection and authentication sequence. The camera system (e.g., incorporating an AXIS Q1808-LE bullet camera mounted at a height of approximately 120 inches) activates to capture vehicle information. The camera system can provide multiple detection ranges, from basic detection at approximately 400 meters to more precise identification at approximately 40 meters, enabling license plate recognition and vehicle authentication. The authentication process leverages the camera's capabilities, including remote zoom and focus functionality with P-Iris control, to ensure accurate plate reading under varying conditions. Upon detecting a vehicle (e.g., vehicle 240 illustrated in FIG. 2), the computer system (e.g., computer system 210 of FIG. 2) initiates the authentication process (408) using the integrated control system. For example, license plate recognition software on the computer system processes the captured image data, comparing it against authorized vehicle records.

Following successful authentication, the smart post system proceeds to an authorization status phase (412). The LED beacon assembly, mounted at the highest point of the smart post or charging post, indicates the charging station's status using programmable color patterns. This visual guidance system helps direct vehicles (vehicle operators or autonomous vehicles) to the appropriate charging position, utilizing the beacon's visibility to efficiently manage traffic flow and reduce unnecessary vehicle movements.

The process 400 progresses through authorization status indication (412) performed using LED beacons, followed by a cable management sequence (416) using a ratcheting pulley mechanism and counterweight system. In some implementations, the computer system coordinates LED beacon patterns across multiple smart posts to guide vehicles to assigned charging stations. The cable management sequence (416) incorporates mechanical features. As the user pulls the charging cable, the grooved roller assembly enables cable movement while maintaining support. The ratcheting pulley mechanism engages automatically, providing controlled movement with integrated locking capabilities when the cable movement stops.

During charging operations (420), the computer system monitors status, updates indicators, and enables communication while monitoring safety parameters using accelerometer detection and emergency stop systems (described in more detail with reference to FIG. 3). The charging operations phase (420) involves monitoring of multiple parameters (electricity flow, temperature, humidity, vehicle movement, etc.). The smart post system updates charging status using the LED indicators, providing clear visual feedback to operators. The integrated intercom system enables two-way communication when needed, while the control system coordinates the monitoring and operational functions. This phase demonstrates the integration of smart features with mechanical operations, ensuring efficient charging while maintaining comprehensive system oversight.

Safety monitoring (424) functions can be performed in parallel with the authentication and charging operations, with multiple systems working in concert. For example, one or more accelerometers, integrated within the system, monitor for impact events. Upon detecting an impact, automatic power disconnection can be triggered using both local and upstream breakers (e.g., connected to upstream power sources 238 illustrated in FIG. 2). An emergency stop system provides additional safety oversight, with manual activation points strategically positioned for easy access.

The process 400 proceeds to charging completion (428), cable retraction, and system reset (432), with parallel processes monitoring critical functions. When charging completes (428), the smart post system initiates the cable retraction sequence. The mechanical systems work together to provide cable handling-the ratcheting pulley mechanism releases, allowing the counterweight system to gently raise the cable while the grooved roller assembly maintains cable alignment.

The system reset (432) phase is performed in preparation for the next charging session. The computer system updates availability indicators for each post using the LED beacons, while maintaining monitoring using the camera system and other sensors. The reset phase ensures that the system returns to its ready state while preserving the operation of parallel monitoring processes. Throughout the operational phases, the camera system can provide monitoring beyond just initial authentication, enabling real-time surveillance of the charging area (e.g., area 242 illustrated in FIG. 2). Status updates flow through the controller, managing both visual indicators and system records. The safety monitoring systems maintain vigilance, while environmental monitoring provides safe system operation under varying conditions.

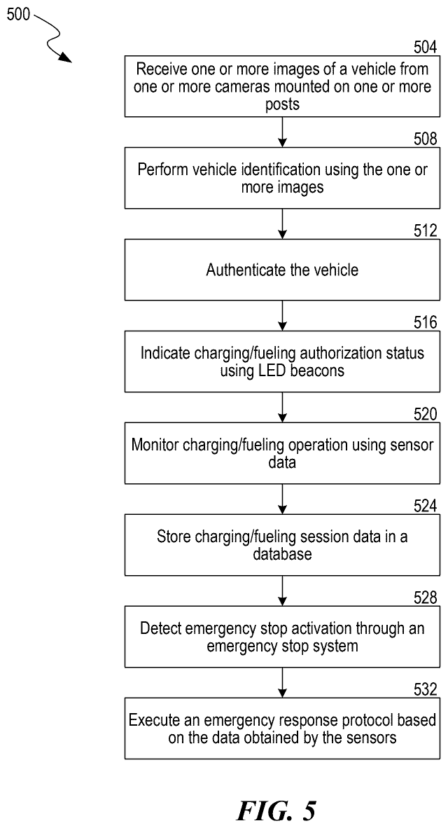

FIG. 5 is a flow diagram that illustrates an example process 500 for operating a smart post system. In some implementations, the process 500 is performed by a computer system. For example, the process can be performed by the computer system 700 illustrated and described in more detail with reference to FIG. 7. Likewise, implementations can include different and/or additional steps or can perform the steps in different orders.

At 504, a computer system (e.g., computer system 210 of FIG. 2) receives one or more images of a vehicle (e.g., vehicle 240 illustrated in FIG. 2) from one or more cameras that can be mounted on one or more smart posts and/or one or more charging posts. For example, multiple cameras can be used in parallel to capture images that are used by the computer system to identify the vehicle. The cameras can be positioned above a smart post or charging post and oriented specifically to capture vehicles in the area forward of the charging station, enabling license plate capture and recognition. For example, one or more cameras can be mounted above a smart post and/or a charging post and oriented to face an area (e.g., area 242 illustrated in FIG. 2) forward of a skid (or other foundation) or a charging post to capture images of vehicles. The cameras capture images (e.g., of a license plate, a logo or emblem on the vehicle, or of the body of the vehicle) and transmit the images to the computer system.

In some implementations, a computer processor and memory are built into a camera system that can perform license plate recognition and/or or vehicle identification and transmit information related to a recognized or unrecognized license plate directly to the computer system. For example, when a vehicle approaches, the camera system processes the license plate image and verifies whether that vehicle's fleet is registered with the site, enabling automatic authentication for charging/fueling. The camera system can also be used to avoid reservation conflicts and validate a reservation in case a bay is reservable. If the camera detects that the wrong truck is parked in the bay which is reserved for a charging or fueling session for another truck, it can be used to trigger a specific visual and audible communication using the smart post beacon LED and intercom system at the bay to alert the occupying driver and site support personnel of the error before the correct truck arrives. The camera system can integrate with notification systems (e.g., computer system 210 shown by FIG. 2) to confirm truck positioning and communicate charging authorization status using the LED beacons mounted on a smart post or charging post. In some implementations, the computer system adjusts parameters (e.g., flash lighting, focus, aperture) of the camera system based on environmental conditions (e.g., cloudy, rainy).

At 508, the computer system performs vehicle identification (e.g., using license plate recognition) based on the received images, e.g., to authenticate fleet vehicles. For example, the computer system can perform license plate recognition on an image of a license plate to identify a vehicle and authenticate the vehicle for charging/fueling. The vehicle can be one of several fleet vehicles registered in a database. In some implementations, the computer system reads text or graphics on a logo or emblem on the vehicle captured in an image to verify that the vehicle is part of the registered fleet. The computer system can also determine that a make and/or model of the vehicle in an image matches data for a registered vehicle.

At 512, the computer system authenticates the vehicle using the license plate recognition. For example, when a truck approaches, the computer system uses the license plate image(s) to automatically verify if that vehicle's fleet is registered with the site. Upon successful license plate recognition and authentication, the smart post system can enable charging of the truck without requiring additional steps from the driver. The extracted license plate information and vehicle identity can be compared against a database of authorized vehicles. Upon a successful match, the vehicle is authenticated, and the computer system signals this authorization status via the LED beacons mounted on a smart post or charging post. If a vehicle is not authenticated or authorized, the computer system can send information to the operator using the LED beacons, an intercom, or a message to the operator's mobile device with instructions on how to proceed. For example, the message can instruct the operator to call a particular number, provide alternative identification, wait a particular amount of time and try again, or move to a particular location

At 516, the computer system transmits control signals to an LED beacon assembly to indicate charging/fueling authorization status. The smart post system includes LED beacon lights mounted on one or more posts that provide visual charging status indicators. The LED indicators can communicate authorization status and bay assignment, with the smart post system 200 able to pulse lights in sequence across multiple charging islands to direct trucks to charging locations. The beacon lights can be communicably coupled to a controller that manages energy and communications functions to coordinate the visual indicators. In some implementations, the computer system can pulse LED beacon lights sequentially across multiple charging islands in a “wave” effect to direct incoming trucks to their assigned charging bays. The controllable LED beacons and amenity lighting can display different colors and patterns, coordinated using the controller (e.g., on the skid or other foundation) to guide vehicle operators or autonomous vehicles.

At 520, when a vehicle is charging, the white portion of the beacon light progressively fills with red/blue light to show the driver how much charge remains and charging progress. The beacon lights are controllable for different colors and patterns using the control system. In some implementations, the computer system controls amenity lighting based on environmental conditions. For example, the smart post system can include horizontal beams with mounted lighting devices that illuminate the translucent polycarbonate canopy. The LED amenity lighting located on the beams can shine up onto the canopy and is controllable for different colors and patterns using the control system. The lighting devices can be mounted on the horizontal beams below the canopy, with multiple lights per beam possible.

In some implementations, the computer system or controller monitors the charging operations using sensor data obtained by sensors (e.g., sensors 212, 234 of FIG. 2) communicably coupled to the computer system. While the computer system is monitoring the charging using the sensor data, embedded accelerometers can detect impacts and/or movement of vehicles, triggering power shutdown using the controller. The smart post system can also include network monitoring capabilities using a wireless module that integrates with a breaker and power distribution systems to track charging operations.

The computer system or controller on the skid or other foundation can manage energy distribution and communications across charging stations. For example, power distribution is handled using a two-level cable tray system-an upper elevation connecting the transformer to grid landing, and a lower elevation distributing power from the transformer across the skid (or other foundation) to individual charging posts. The smart post system can integrate multiple power sources including grid power, generators, and/or batteries using breakers and power distribution components. The network box and main breaker coordinate power delivery across charging posts using integrated splitters and converters, with specific spacing requirements maintained for equipment cooling and maintenance access.

At 524, the computer system stores charging/fueling session data associated with the charging/fueling operations in a database (e.g., on computer server 236 of FIG. 2). The smart post system can include a wireless module communicably coupled to the controller, breaker, and power distribution components for monitoring charging operations. The controller can also manage energy and communications functions, integrating data from multiple sources including charging status, vehicle authentication, and power/or distribution. The controller can monitor charging operations in real-time, enabling features such as LED beacon status updates that show charging progress.

At 528, the computer system detects emergency stop activation using an emergency stop system (e.g., the emergency stop system 314 of FIG. 3). For example, the smart post system includes emergency stop buttons mounted on one or more posts that trigger a safety cascade similar to the accelerometers. When activated, the emergency stop system can send a signal to the controller. The controller can initiate multiple simultaneous actions. For example, the controller triggers an upstream shunt trip breaker (e.g., connected to upstream power sources 238 illustrated in FIG. 2) to cut off incoming power to the skid or other foundation. The controller can also activate the breaker to shut down equipment on the skid or other foundation. The emergency stop system can also deactivate onboard energy sources like generators and batteries to ensure complete power isolation.

At 532, the computer system executes an emergency response protocol based on the sensor data. For example, when sensor data triggers an emergency response, the smart post system can execute multiple coordinated actions using the computer system and/or controller. Upon the receipt of data from the integrated sensors (e.g., sensors 212, 234 of FIG. 2) indicating an anomalous condition, the computer system can execute one or more emergency response protocols. A protocol can include triggering the disconnection of electrical power or hydrogen flow by activating both an upstream shunt trip breaker to cut off incoming power and a breaker to shut down local equipment. Furthermore, the computer system may also deactivate any onboard energy sources, such as generators and batteries, to ensure complete power isolation. The controller can monitor these emergency protocols, providing a rapid response to potential safety hazards detected by the integrated sensors.

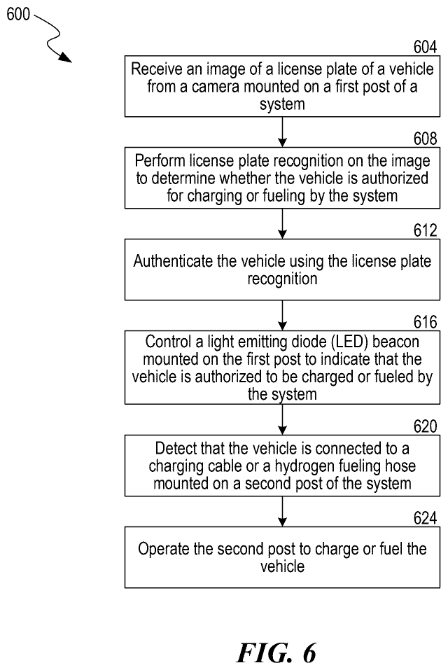

FIG. 6 is a flow diagram that illustrates an example process 600 for operating a smart post system. In some implementations, the process 600 is performed by a computer system. For example, the process can be performed by the computer system 700 illustrated and described in more detail with reference to FIG. 7. Likewise, implementations can include different and/or additional steps or can perform the steps in different orders.

At 604, a computer system receives one or more images of a license plate of a vehicle from one or more cameras mounted on a first post (e.g., smart post 202 of FIG. 2) of a smart post system. The cameras, part of an integrated camera system, can be positioned on at least one of the smart posts or potentially on a charging post, oriented to capture an area where vehicles approach for charging or fueling. The camera functions to capture visual data, specifically an image that includes the license plate of the vehicle. The camera system may also utilize features like remote zoom and focus with P-Iris control to improve image capture for accurate recognition under various environmental conditions. In some implementations, the camera itself may have built-in processing capabilities to perform initial license plate recognition before transmitting data to the computer system.

At 608, the computer system performs license plate recognition on the image(s) to determine whether the vehicle is authorized for charging or fueling. For example, the computer system can use license plate recognition software to process the image. The processing can include analyzing the image to identify and extract the alphanumeric characters of the vehicle's license plate. The extracted license plate data can be compared against a database of authorized vehicles, which may include registered fleet vehicles or other permitted users of the charging or fueling infrastructure.

At 612, the computer system authenticates the vehicle based on the extracted license plate data. This authentication step involves comparing the recognized license plate against a database of authorized vehicle records. The computer system determines the authorization status based on whether a successful match is found during this comparison, establishing if the vehicle is permitted to utilize the system for charging or fueling. For example, if the recognized license plate matches an entry in the authorized database, the vehicle is deemed authenticated by the smart post system.

At 616, the computer system transmits control signals to an LED beacon mounted on the first post to visually communicate the vehicle's authorization status for charging or fueling. The LED beacon can incorporate programmable multi-color status indicators that can be configured to display distinct colors and patterns, making the authorization status visible to the vehicle operator. The control signals from the computer system dictate the specific visual output of the LED beacon, providing immediate feedback on the authorization outcome. In some implementations, the computer system controls the programmable LED beacons mounted on one or more posts to guide vehicles (vehicle operators or autonomous vehicles) to the appropriate charging or fueling location. The LED beacons can display different colors and patterns to indicate bay assignments and authorization status, potentially pulsing sequentially across multiple posts to direct incoming vehicles. Additionally, or alternatively, the LED beacon can display different colors and/or patterns to indicate whether a charging stall is available or occupied, whether a charging stall is private or publicly accessible, whether a charging stall is out of service, whether a vehicle occupying a charging stall is actively being charged or merely idling, and/or the like.

For example, in systems including multiple posts, the computer system can orchestrate the programmable multi-color status indicators of LED beacons mounted on at least some of these posts to guide a vehicle towards a designated bay or designated second post (e.g., charging post 206 of FIG. 2). In some implementations, the second post is the same as the first post. Following vehicle authentication, the computer system can transmit control signals to the LED beacons, causing them to display specific colors and patterns indicative of the route or the availability of the second post. In some implementations, this guidance can involve a sequential pulsing of the LED beacons across the charging infrastructure, creating a visual “wave” effect to clearly direct the vehicle to its intended charging or fueling location. The coordinated illumination of the LED beacons, managed by the computer system, provides more efficient traffic flow and reduces unnecessary vehicle movements within the charging or fueling station.

At 620, upon physical connection of a vehicle to a charging cable assembly or a hydrogen fueling hose mounted on the second post of the system, the computer system registers this event. In the case of electric vehicle charging, the detection can occur through monitoring the electrical circuit for a completed connection and the initiation of power draw. For hydrogen fueling, a sensor within the fueling hose or the vehicle interface can signal a secure connection and the commencement of fuel transfer. This detection allows the computer system to proceed with initiating and monitoring the charging or fueling process, updating status indicators, and providing safe operation.

At 624, the computer system operates the second post to initiate the charging or fueling process by transmitting appropriate control signals. For electric vehicles, this can include enabling power delivery through the charging cable assembly to the vehicle's connector. A controller on the skid or other foundation can manage energy distribution, such that the correct power levels are supplied. For hydrogen fueling, the operation can include commencing the flow of hydrogen through the fueling hose. Throughout the operation, the computer system can monitor the charging or fueling status using sensor data and network monitoring capabilities.

During the operation of the second post for charging or fueling, the computer system monitors the process utilizing sensor data. For electric vehicle charging, the system tracks energy delivery and charging status. For hydrogen fueling, relevant parameters such as pressure and flow rate are monitored. The monitoring data can be used by the computer system to control the LED beacons. For example, the progress of the charging or fueling session can be communicated to the operator by displaying a progressive fill pattern. In the context of EV charging, the white portion of the beacon light can progressively fill with blue light, indicating the amount of charge remaining and the advancement of the charging process. Similarly, for hydrogen fueling, the LED beacon can employ a progressive fill of color to represent the amount of fuel transferred.

In some implementations, the computer system stores the vehicle identification data derived from the recognized license plate in a database. Upon initiation and throughout the charging or fueling operation, the computer system can log information describing the charging or fueling session for each vehicle in the same or a related database. The session information can encompass parameters such as the start and end times of the session, the amount of energy or fuel dispensed, the charging/fueling rate, and potentially the specific post utilized. An integrated control system can coordinate the data storage, maintaining records of vehicle usage and charging/fueling activities for operational and analytical purposes.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computer system 700 to mediate data in a network 714 with an entity that is external to the computer system 700 using any communication protocol supported by the computer system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A system comprising:
one or more posts mounted on a foundation,
wherein the one or more posts are configured to:
communicate with operators of electric vehicles for charging the electric vehicles using the system;
a camera mounted on at least one of the one or more posts,
wherein the camera is configured to capture an image of at least one electric vehicle;
a light emitting diode (LED) beacon mounted on at least one of the one or more posts,
wherein the LED beacon includes programmable multi-color status indicators to indicate a charging authorization status of the at least one electric vehicle;
an intercom mounted on at least one of the one or more posts,
wherein the one or more posts are configured to communicate with the operators using the intercom and the LED beacon; and
a computer system communicably coupled to the camera, the LED beacon, and the intercom,
wherein the computer system is configured to:
process the image to determine whether the at least one electric vehicle is authorized for charging by the system,
control the LED beacon to indicate the charging authorization status of the at least one electric vehicle;
control the LED beacon to direct the at least one electric vehicle towards a particular post for charging the at least one electric vehicle; and
control the particular post to charge the at least one electric vehicle.

2. The system of claim 1, wherein the image depicts a license plate of the at least one electric vehicle, and
wherein processing the image comprises performing license plate recognition on the image to determine whether the at least one electric vehicle is authorized for charging by the system.

3. The system of claim 1, comprising an LED light source mounted on at least one of the one or more posts,
wherein the LED light source is configured to illuminate an area adject to the foundation.

4. The system of claim 1, wherein the LED beacon is configured to:
display charging progress information of the at least one electric vehicle using a progressive fill pattern.

5. The system of claim 1, wherein the LED beacon is configured to:
display a warning signal to prevent a collision between the at least one electric vehicle and the foundation or the particular post while directing the at least one electric vehicle towards a particular post.

6. The system of claim 1, comprising:
one or more charging cable assemblies,
wherein each charging cable assembly is mounted on a respective post, and
wherein each charging cable assembly comprises:
a charging cable, and
a connector for connecting to an electric vehicle for charging the electric vehicle using the charging cable.

7. The system of claim 1, wherein the computer system is configured to:
determine that the at least one electric vehicle is connected to a charging cable assembly mounted on the particular post; and
control charging of the at least one electric vehicle using the charging cable assembly.

8. A system comprising:
one or more posts mounted on a foundation and configured to perform communication with operators of vehicles for at least one of charging or fueling the vehicles by the system;
a camera mounted on one of the one or more posts and configured to capture images of the vehicles;
a light source mounted on one of the one or more posts and configured to indicate a charging authorization status or a fueling authorization status of at least one vehicle; and
a computer system communicably coupled to the camera and the light source,
wherein the computer system is configured to:
process at least one image of the at least one vehicle to determine whether the at least one vehicle is authorized for charging or fueling by the system; and
direct the at least one electric vehicle, using the light source, towards a particular post for charging or fueling the at least one vehicle.

9. The system of claim 8, comprising:
a hydrogen fueling hose mounted to the particular post for fueling the at least one vehicle.

10. The system of claim 8, comprising:
an intercom mounted on one of the one or more posts,
wherein the communication is performed using the intercom and the light source.

11. The system of claim 8, wherein the at least one image depicts a license plate of the at least one electric vehicle, and
wherein processing the at least one image comprises performing license plate recognition on the at least one image.

12. The system of claim 8, wherein the light source is configured to:
display charging progress information or fueling progress information of the at least one electric vehicle using a progressive fill pattern.

13. The system of claim 8, wherein the computer system is configured to:
receive an emergency stop signal from the particular post; and
trigger disconnection of electrical power or hydrogen flow to the particular post.

14. The system of claim 8, comprising an accelerometer communicably coupled to the computer system,
wherein the computer system is configured to:
receive a signal from the accelerometer indicating an impact to the system; and
trigger disconnection of electrical power or hydrogen flow to the system.

15. A method performed by a system, the method comprising:
receiving, by one or more computer processors, an image of a license plate of a vehicle from a camera mounted on a first post of the system;
performing license plate recognition on the image to determine whether the vehicle is authorized for charging or fueling by the system;
authenticating the vehicle using the license plate recognition;
controlling a light emitting diode (LED) beacon mounted on the first post to indicate that the vehicle is authorized to be charged or fueled by the system;
detecting that the vehicle is connected to a charging cable or a hydrogen fueling hose mounted on a second post of the system; and
operating the second post to charge or fuel the vehicle.

16. The method of claim 15, wherein the system comprises multiple posts, and wherein the method comprises:
controlling programmable multi-color status indicators of multiple LED beacons mounted on at least some of the multiple posts to direct the vehicle to the second post.

17. The method of claim 15, comprising:
monitoring charging or fueling of the vehicle by the second post; and
displaying charging or fueling progress information for the vehicle using a progressive fill pattern on the LED beacon.

18. The method of claim 15, comprising:
receiving a signal received from an accelerometer indicating an impact to the system; and
triggering disconnection of electrical power or hydrogen flow to the second post.

19. The method of claim 15, wherein the system comprises multiple posts, and wherein the method comprises:
controlling distribution of electrical power or hydrogen flow across the multiple posts to charge or fuel multiple vehicles.

20. The method of claim 15, comprising:
storing, in a database, a vehicle identification of the vehicle based on the license plate recognition; and
storing, in the database, information describing a charging or fueling session for the vehicle.
